(19) United States
(12) Patent Application Publication
(10) Pub. No.: US 2021/0278952 A1
(43) Pub. Date: Sep. 9, 2021

(54) ELECTRONIC APPARATUS, CONTROL METHOD OF ELECTRONIC APPARATUS, AND NON-TRANSITORY COMPUTER READABLE MEDIUM

(71) Applicant: CANON KABUSHIKI KAISHA, Tokyo (JP)

(72) Inventor: Koji Yoshida, Kanagawa (JP)

(21) Appl. No.: 17/181,948

(22) Filed: Feb. 22, 2021

(30) Foreign Application Priority Data
Mar. 5, 2020 (JP) 2020-038009

(51) Int. Cl. G06F 3/041; H04N 5/232

(52) U.S. Cl. CPC G06F 3/04186; H04N 5/232933; G06F 3/04883; H04N 5/232939; G06F 2203/04105

(57) ABSTRACT

An electronic device performs control such that in a non-restricted state, a particular function corresponding to a display item is executed in response to particular touch operation performed on the display item even when pressing which satisfies a predetermined condition is not detected, perform control such that in a restricted state, the particular function corresponding to the display item is not executed even when the particular touch operation is performed on the display item in a case where pressing which satisfies the predetermined condition is not detected, and perform control such that in the restricted state, the particular function corresponding to the display item is executed in a case where pressing which satisfies the predetermined condition is detected in a state where the display item is touched.

### BACKGROUND

### Field of the Disclosure

The present disclosure relates to an electronic device and particularly to a controlling method therefor in a locked. state (restricted state) in which touch operation is restricted.

### Description of the Related Art

In conventional touch panels which accept user's touch operation, a technique is known which restricts the user from touching a region other than a touch enabled. region, in which touch operation is enabled, in order to prevent the user from causing erroneous operation by inadvertently touching an unintended position.

According to Japanese Patent Application Publication No. 2017-215852, it is proposed that from a touch operation restricted state (a locked state) for preventing erroneous operation, it is possible to unlock the locked states by touching a particular region. The purpose of limiting the touch area for unlocking the locked state is to prevent the locked state from being unlocked by an unintended touch.

However, according to the conventional method disclosed in Japanese Patent Application Publication No. 2017-215852, a locked state cannot be unlocked by touching a function icon in the locked state. In addition, it is difficult for the user to understand that the locked state cannot be unlocked without touching a specific area. In addition, it takes many touches for the user to execute a desired function (such as displaying a setting value change screen corresponding to a particular setting item) from the locked state. For example, it may be necessary to touch a particular region (a first touch) different from the region of a function icon, to which a function desired by the user is assigned, and unlock the locked state and thereafter touch the function icon (a second touch) to select the function.

### SUMMARY

The present disclosure provides an electronic device which allows the possibility of erroneous operation due to unintended touches to be reduced and a desired function to be performed with a smaller number of operations.

An electronic device according to the present disclosure, includes: a touch detector configured to detect touch operation on an operation surface; a pressing detector configured to detect pressing on the operation surface; and at least one memory and at least one processor which function as: a setting unit configured to set a restricted state in which function execution by at least particular touch operation is restricted; and a control unit configured to perform control such that in a non-restricted state, which is not the restricted state, a particular function corresponding to a display item is executed in response to the particular touch operation performed on the display item even when the pressing detector does not detect pressing which satisfies a predetermined condition, perform control such that in the restricted state, the particular function corresponding to the display item is not executed even when the particular touch operation is performed on the display item in a case where the pressing detector does not detect pressing which satisfies the predetermined condition, and perform control such that in the restricted state, the particular function corresponding to the display item is executed in a case where the pressing detector detects pressing which satisfies the predetermined condition in a state where the display item is touched.

Further features of the present disclosure will become apparent from the following description of exemplary embodiments with reference to the attached drawings.

### BRIEF DESCRIPTION OF THE DRAWINGS

FIGS. 1A and 1B are external views of a digital camera;

FIG. 2 is a block diagram of an exemplary configuration of the digital camera;

FIG. 3 is a flowchart for illustrating imaging mode setting processing;

FIG. 4 is a flowchart for illustrating Q setting screen processing;

FIG. 5 is a flowchart for illustrating function setting screen processing; and

FIGS. 6A to 6D are views for illustrating exemplary displays at display screens.

### DESCRIPTION OF THE EMBODIMENTS

### External Views of Digital Camera 100

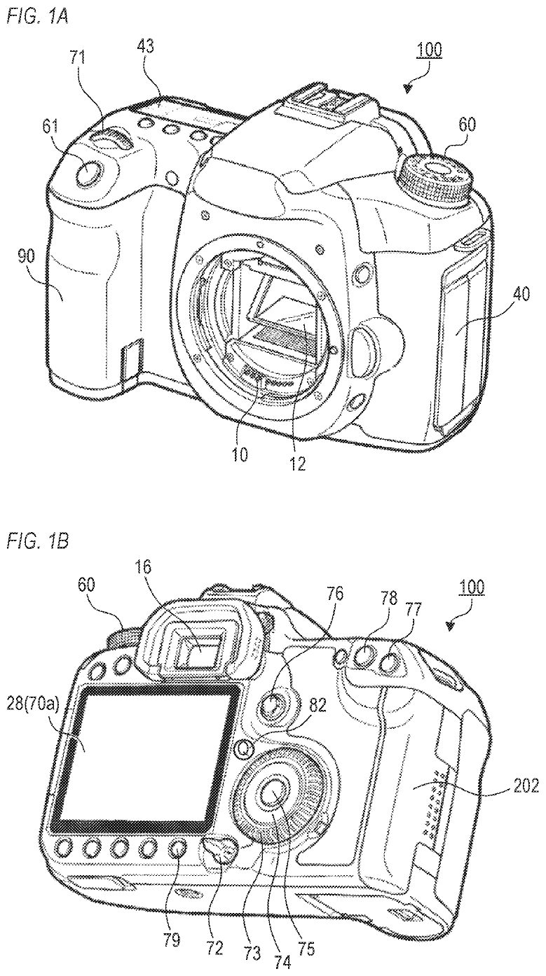

Hereinafter, a preferred embodiment of the present disclosure will he described in conjunction with the accompanying drawings. FIGS. 1A and 1B are external views of an exemplary digital camera 100 to which the present disclosure can he applied. FIG. 1A is a front perspective view of the digital camera 100, and FIG. 1B is a rear perspective view of the digital camera 100.

A display unit 28 is provided at the back of the digital camera 100 to display images and various kinds of information. A touch panel 70a can detect touch operation on the display surface of the display unit 28 (the operation surface of the touch panel 70a). An outside viewfinder display unit 43 is provided on the upper surface of the digital camera 100 to display various setting values for the digital camera 100 such as a shutter speed and an aperture. A shutter button 61 is an operation member for performing a shooting instruction. A mode selecting switch 60 is an operation member for switching among various modes. A terminal cover 40 protects a connector (not shown) for example with a connection cable which connects the digital camera 100 with an external device.

A main electronic dial 71 is a rotating operation member and setting values such as a shutter speed and an aperture can be changed by turning the main electronic dial 71. A power switch 72 is an operation member which switches between the power on and off states of the digital camera 100. A sub-electronic dial 73 is a rotation operation member, and a selection frame (cursor) can be moved or an image can be fed by turning the sub-electronic dial 73. A four-way key 74 can have its upper, lower, left, and right portions pressed, and processing according to each of the pressed portions of the four-way key 74 can be carried out. In the description of the embodiment, the four-way key 74 is an integral operation member, but upper, lower, right, and left buttons may be independently provided as direction buttons. A SET button 75 is a push button and mainly used to determine an item to select.

A live view (LV) button 76 switches between the on and off states of LV in a still image shooting mode. In a moving image shooting mode, the LV button 76 is used to instruct the start or stop of moving image shooting (recording). A magnifying button 77 is an operation button for switching between the on and off states of a magnifying mode in a live view display in a shooting mode and changing the magnifying ratio in the magnifying mode. In a playback mode, the magnifying button 77 serves as a magnifying button to magnify a playback image or increase the magnification ratio thereof. A reduction button 78 is a button to reduce the magnification ratio of a magnified playback image and to shrink the displayed image. A playback button 79 is an operation button which switches between the shooting mode and the playback mode. When the playback button 79 is pressed during the shooting mode, the mode is changed to the playback mode, and the latest image among the images recorded in the recording medium 200 (which will be described) can be displayed at the display unit 28.

A quick return mirror 12 is moved up and down by an actuator which is not shown in response to an instruction from a system control unit 50 (which will be described). A communication terminal 10 is used. for communication between the digital camera 100 and a lens unit 150 (which is removable and will be described). An eyepiece viewfinder 16 (hereinafter referred to as the viewfinder 16) is a look-in type viewfinder for checking the focus or composition of an optical image of an object obtained through the lens unit 150 as the user observes a focusing screen 13 (which will be described). A lid 202 is the lid of a slot which stores a recording medium 200. A grip part 90 is a holder shaped to be easily grasped by the right hand when the user tries to aim the digital camera 100.

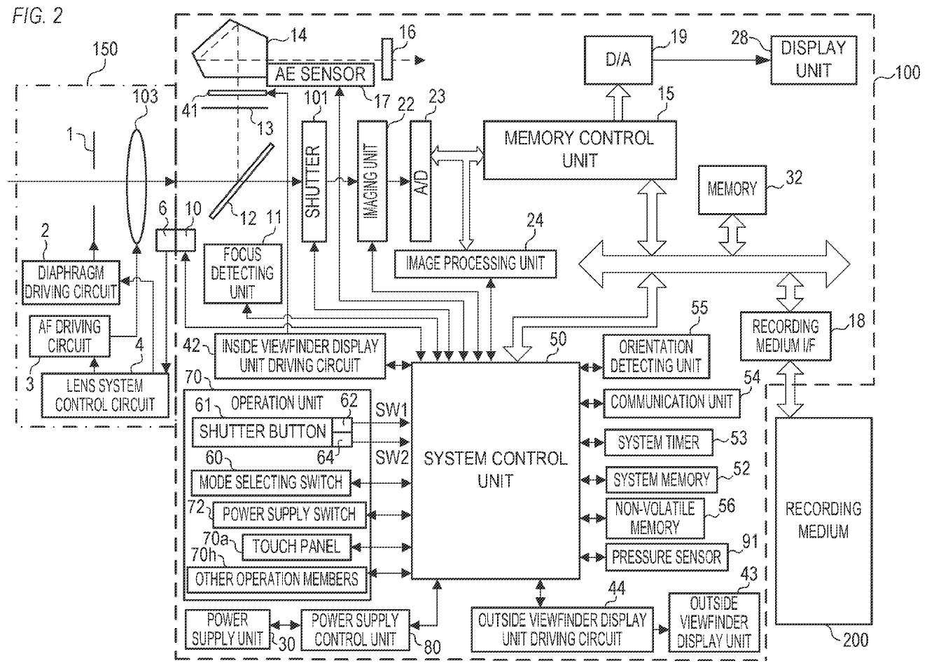

FIG. 2 is a block diagram of an exemplary configuration of the digital camera 100.

The lens unit 150 is equipped with a replaceable photographic lens. A lens 103 typically includes a plurality of lenses while only one lens is illustrated in FIG. 2 for the sake of brevity A communication terminal 6 is used by the lens unit 150 for communication with the side of the digital camera 100, and the communication terminal 10 is used by the digital camera 100 to communicate with the side of the lens unit 150. The lens unit 150 communicates with the system control unit 50 through the communication terminals 6 and 10, The lens unit 150 controls a diaphragm 1 through a diaphragm driving circuit 2 by an internal lens system control circuit 4 provided therein. The lens unit 150 also is focused by displacing the position of the lens 103 by the lens system control circuit 4 through an AF driving circuit 3.

An automatic exposure (AE) sensor 17 measures the brightness of an object (object light) through the lens unit 150.

A focus detecting unit 11 outputs defocus amount information to the system control unit 50. The system control unit 50 controls the lens unit 150 on the basis of the defocus amount information and performs phase difference auto focusing (AF). The AF may be contrast AF or imaging plane phase difference AF rather than the phase difference AF.

The quick return mirror 12 (hereinafter referred to as the mirror 12) is moved up and down by an actuator (not shown) in response to instructions from the system control unit 50 for example during exposure, live view shooting, and moving image shooting. The mirror 12 is used for switching an incoming light beam from the lens 103 between the side of viewfinder 16 and the side of the imaging unit 22. The mirror 12 is normally arranged to direct (reflect) a light beam to the viewfinder 16 (with the mirror being down), while when imaging or live view display is performed, the mirror 12 is raised upward to direct the light beam to the imaging unit 22 and avoids the light beam (with the mirror being up). The mirror 12 is a half minor so that the center thereof can transmit a part of the light beam, and the mirror 12 transmits a part of the light beam, so that the light comes into the focus detecting unit 11 for focus detection.

The user observes the focusing screen 13 through a pentaprism 14 and the viewfinder 16 and can check the focus and composition of an optical image of an object obtained through the lens unit 150.

A shutter 101 is a focal plane shutter which allows the exposure time of the imaging unit 22 to be controlled freely under the control of the system control unit 50.

The imaging unit 22 is an imaging device (image sensor) including a Charge-Coupled Device (CCD) or Complementary Metal-Oxide-Semiconductor (CMOS) device which converts an optical image into an electrical signal. The imaging unit 22 may include an imaging plane phase difference sensor which outputs defocus amount information to the system control unit 50. An Analog-to-Digital (A/D) converter 23 converts an analog signal output from the imaging unit into a digital signal.

An image processing unit 24 subjects data from the A/D converter 23 or data from the memory control unit 15 to predetermined processing (for example resizing processing such as pixel interpolation or reduction and color conversion processing). The image processing unit 24 performs predetermined arithmetic processing using image data captured by imaging, and the system control unit 50 performs exposure control or ranging control on the basis of a calculation result obtained by the image processing unit 24. In this way, through the lens (TTL) auto focusing (AF) processing, automatic exposure (AE) processing, or flash pre-light emission (EF) processing may be performed. The image processing unit 24 thriller performs predetermined arithmetic processing using the image data captured by imaging and performs through the lens (TTL) auto-white balance (AWB) processing on the basis of the obtained calculation result.

Output data from the A/D converter 23 is written in a memory 32 through the image processing unit 24 and the memory control unit 15. Alternatively, the output data from the A/D converter 23 is written in the memory 32 through the memory control unit 15 but not through the image processing unit 24. The memory 32 stores image data obtained by the imaging unit 22 and converted into digital data by the A/D converter 23 and image data for display at the display unit 28. The memory 32 has a sufficient storage capacity to store a predetermined number of still images and moving images and sounds for a predetermined time period.

The memory 32 also serves as a memory (video memory) for image display. A Digital to Analog (D/A) converter 19 converts the data for image display stored in the memory 32 into analog signals and provides the signals to the display unit 28. In this way, the display image data written in the memory 32 is displayed by the display unit 28 through the D/A converter 19. The display unit 28 carries out display according to the analog signals from the D/A converter 19 on a display such as an Liquid Crystal Display (LCD) and an organic EL. The digital signals AID converted by the A/D converter 23 and stored in the memory 32 are converted into analog signals at the D/A converter 19 and these signals are sequentially transferred to the display unit 28 for display. In this way, the function of an electronic viewfinder can be realized, and through-image display (live view display (LV display)) can be performed. Hereinafter, an image displayed in the live view display will be referred to as a live view image (LV image).

In the inside viewfinder display unit 41, a frame (AF frame) representing a ranging point where auto focusing is currently in progress or an icon representing the set state of the digital camera 100 is displayed through an inside viewfinder display unit driving circuit 42.

Various setting values for the camera such as a shutter speed and an aperture are displayed in the outside viewfinder display unit 43 through an outside viewfinder display unit driving circuit 44.

A non-volatile memory 56 is an electrically erasable and recordable memory such as Electrically Erasable Programmable Read-Only Memory (EEPROM). For example, constants and a program for operating the system control unit 50 are recorded in the non-volatile memory 56. Here, the program refers to a program for executing processing in various flowcharts according to the embodiment which will be described.

The system control unit 50 includes at least one processor and/or at least one circuit and controls the entire digital camera 100. The system control unit 50 executes the program recorded in the non-volatile memory 56 to carry out various kinds of processing according to the present embodiment which will be described. The system memory 52 is for example a RAM, and the system control unit 50 deploys, in the system memory 52, for example constants and variables for the operation of the system control unit 50 and a program read out from the non-volatile memory 56. The system control unit 50 also controls for example the memory 32, the D/A converter 19, and the display unit 28 and thus performs display control.

A system timer 53 is a clock unit which measures time used for various kinds of control and the time of a built-in clock.

The power supply control unit 80 includes a battery detecting circuit, a Direct Current to Direct Current (DC-DC) converter, a switch circuit which switches the block to he energized, and detects whether a battery is installed, the type of the installed battery if any, and the remaining amount of the battery. The power supply control unit 80 also controls the DC-DC converter on the basis of the detection results and an instruction from the system control unit 50 and provides necessary voltage to various elements including the recording medium 200 for a necessary period of time. A power supply unit 30 includes a primary battery such as an alkaline battery or a lithium battery, a secondary battery such as a NiCd battery, a NiMH battery, and a Li battery, and an AC adapter.

The recording medium I/F 18 is an interface with the recording medium 200 such as a memory card or a hard disk. The recording medium 200 is a recording medium such as a memory card for recording captured images and may include a semiconductor memory or a magnetic disk.

A communication unit 54 transmits/receives video and audio signals to/from an external device connected wirelessly or by a wired cable. The communication unit 54 can also be connected to a wireless local area network (LA) or the Internet. The communication unit 54 can also communicate with external devices by Bluetooth (registered trademark) or Bluetooth Low Energy. The communication unit 54 can transmit images captured by the imaging unit 22 (including an LV image) or images recorded in the recording medium 200 and can receive images or other various kinds of information from the external device.

An orientation detecting unit 55 detects the. orientation of the digital camera 100 with respect to the gravitational direction. It can be determined whether an image captured by the imaging unit 22 has been captured by the digital camera 100 facing horizontally or vertically on the basis of the orientation detected by the orientation detecting unit 55. The system control unit 50 can add orientation information corresponding to the orientation detected by the orientation detecting unit 55 to the image file of the image captured by the imaging unit 22 or rotate the image for recording. An acceleration sensor or a gyro sensor can be used as the orientation detecting unit 55. The movement of the digital camera 100 (for example whether it is panning, tilting, lifting or stationary) can be sensed using the acceleration sensor or gyro sensor serving as the orientation detecting unit 55.

The operation unit 70 includes various operation members (such as push buttons, rotation dials, touch sensors) as input units for receiving operation from a user (user operation), and is used to input various operation instructions to the system control unit 50. According to the embodiment, as shown in FIG. 2, the operation unit 70 includes the mode selecting switch 60, the shutter button 61, the power switch 72, the touch panel 70a, and other operation members 70h. The other operation members 70h include the main electronic dial 71 shown in FIGS. 1A and 1B, the sub-electronic dial 73, the four-way key 71, the SET button 75, the LV button 76, the magnifying button 77, the reduction button 78, the playback button 79, and a Q button 82.

Each of the operation members of the operation unit 70 is assigned a function according to each scene by selectively operating various function icons displayed on the display unit 28, and acts as a function button. The function buttons may include an end button, a return button, an image feed button, a jump button, a narrowing down button, and an attribute change button. For example, when the menu button is pressed, a menu screen which enables various kinds of setting is displayed at the display unit 28. The user can perform various kinds of setting intuitively using the menu screen displayed on the display unit 28 and the four-way key 74 or the SET button 75.

The mode selecting switch 60 switches the operation mode of the system control unit 50 among the still image shooting mode, the moving image shooting mode, and the playback mode. The still image shooting mode include the auto shooting mode, an auto scene determination mode, a manual mode, a diaphragm priority mode (Av mode), a shutter speed priority mode (Tv mode), and a program AE mode (P mode). In addition, there are various scene modes and custom modes set for shooting for each shooting scene. The mode selecting switch 60 allows the user to switch the mode directly to one of these modes. Alternatively, after switching to a shooting mode list screen by the mode selecting switch 60, any of the other operation members may be used to selectively switch to any of multiple displayed modes. Similarly, the moving image shooting mode may include a plurality of modes.

The shutter button 61 includes a first shutter switch 62 and a second shutter switch 64. The first shutter switch 62 is turned on in the middle of the operation of the shutter button 61 or by a so-called half-push (for a recording preparation instruction) and generates a first shutter switch signal SW1. The system control unit 50 starts shooting preparation operation such as auto focusing (AF) processing, auto exposure (AE) processing, auto white balance (AWB) processing, and flash pre-light emission (EF) processing in response to the first shutter switch signal SW1. The second shutter switch 64 is turned on and generates a second shutter switch signal SW2 when the operation of the shutter button 61 is completed or a so-called full push (for a shooting instruction) is carried out. The system control unit 50 starts a series of shooting processing operations starting from reading of a signal from the imaging unit 22 to writing of a captured image as an image file in the recording medium 200 in response to the second shutter switch signal SW2.

The touch panel 70a and the display unit 28 may be integrally formed. For example, the touch panel 70a is configured to have such a light transmittance that display by the display unit 28 is not prevented and is mounted on the upper layer of the display surface of the display unit 28. Input coordinates on the touch panel 70a are associated with display coordinates on the display surface of the display unit 28. In this way, a graphical user interface (GUI) which allows the user to feel as if the screen displayed on the display unit 28 can be directly operated. The system control unit 50 can detect kinds of operation on the touch panel 70a or states as follows.
A new touch to the touch panel 70a by a finger or pen which has not been touched on the touch panel 70a, i.e., the start of a touch (hereinafter referred to as a touch-down).
A state in which a finger or pen is touching the touch panel 70a (hereinafter referred to as a “touch-on”).
Movement of a finger or pen while still touching the touch panel 70a (hereinafter referred to as a “touch-move”).
Movement (release) of a finger or pen which has been touching the touch panel 70a away from the touch panel 70a or the end of a touch (hereinafter referred to as a “touch-up”).
Nothing touches the touch panel 70a (hereinafter referred to as a “touch-off”).
A touch-down on the touch panel 70a followed by a touch-up without a touch move (hereinafter referred to as a “tap”).

When a touch-down is detected, a touch-on is also detected at the same time. After the touchdown, the touch-on usually continues to be detected unless a touch-up is detected. A touch-on is detected at the same time when a touch-move is detected. Even when a touch-on is detected, a touch-move is not detected unless the touched position is moved. After touch-ups by all the fingers or pens that have been touching are detected, a touch-off follows.

These kinds of operation and states and the coordinates of the position in which the finger or pen touches on the touch panel 70a are notified to the system control unit 50 through an internal bus. The system control unit 50 determines what kind of operation (touch operation) has been performed on the touch panel 70a on the basis of the notified information. As for a touch-move, the moving direction of the finger or pen moving on the touch panel 70a can be determined for each of the vertical and horizontal components on the touch panel 70a on the basis of changes in the position coordinates. When a touch-move over at least a predetermined distance is detected, it is determined that sliding operation has been performed.

The operation of quickly moving the finger in contact with the touch panel 70a over a certain distance and then releasing the finger is referred to as a flick. Stated differently a flick is operation to quickly trace on the touch panel 70a as if lightly striking the panel with the finger. When a touch-move at at least a predetermined speed over at least predetermined distance is detected, followed directly by detection of a touch-up, it can be determined that a flick has been performed (sliding operation followed by a flick is determined). Touch operation to simultaneously touch multiple positions (such as two positions) and bring these touching positions close to each other is referred to as a “pinch-in”, and touch operation to move these touching positions apart from each other is referred to as a “pinch-out”. A pinch-out and a pinch-in are collectively referred to as pinch operation (or simply referred to as a “pinch”).

The touch panel 70a may be any of various types of panels which include a resistance film type, a capacitance type, a surface acoustic wave type, an infrared type, an electromagnetic induction type, an image recognition type, and an optical sensor type. A touch is detected when a finger or pen comes into contact with the touch panel or when a finger or pen conies close to the touch panel depending on the type, and either of the types can be used.

A pressure sensor 91 is a sensor for detecting the strength of touch operation and detects the pressing force (pressure detection and pressing detection) on the display surface (the operation surface of the touch panel 70a) of the display unit 28. The pressure sensor 91 can continuously detect the strength of the pressing force when pressed by touch operation on the display unit 28. The pressure sensor 91 may be configured to include one or more strain gauge sensors on a portion that is distorted by pressing force on the display surface of the display unit 28, and detect the pressing force on the display surface of the display unit 28 by the output value from the strain gauge sensor. Alternatively, the distance between the finger on the display surface and a capacitance sensor due to the distortion of the display surface caused by the pressing force on the display surface of the display unit 28 is calculated from a capacitance value from the capacitance sensor arranged parallel to the display unit 28. The pressure may then be calculated on the basis of the distance, or the distance may be treated as being equivalent to the pressure.

The pressure sensor 91 may be any other type of pressure sensor capable of detecting pressing force on the operation surface of the touch panel 70a. For example, when operation on the operation surface is performed using a stylus, a sensor provided on the stylus side to detect pressure applied to the tip of the stylus may be used, and the strength (pressing force) of touch operation may be detected on the basis of the output from the sensor.

Alternatively, the touch force on the operation surface or an alternative to the pressure of the touch (for example, the distance between the finger and the capacitive sensor on the display surface (operation surface) described above or the touch area) may be detected. Various methods and various sensors or a combination of multiple sensors (such as weighted averages) may also be used to detect the strength (pressure) of touch operation. The pressure sensor 91 may be formed integrally with the touch panel 70a.

Hereinafter, pressing operation as operation by which pressure of at least a threshold value (at least predetermined pressing force) is applied by touching the display surface of the display unit 28 (the operation surface of the touch panel 70a) will be referred to as a touch push and is distinguished from touch operation which does not include pressure of at least the threshold value.

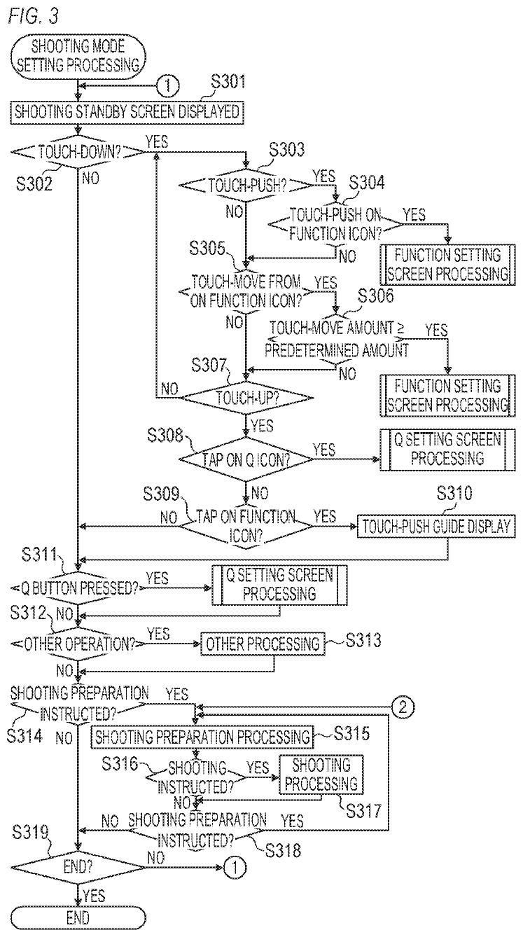

FIG. 3 is a flowchart for illustrating details of shooting mode setting processing performed by the digital camera 100. The processing is carried out as the system control unit 50 deploys and executes a program recorded in the non-volatile memory 56 in the system memory 52. For example, the processing in FIG. 3 starts when the digital camera 100 is activated in the shooting mode.

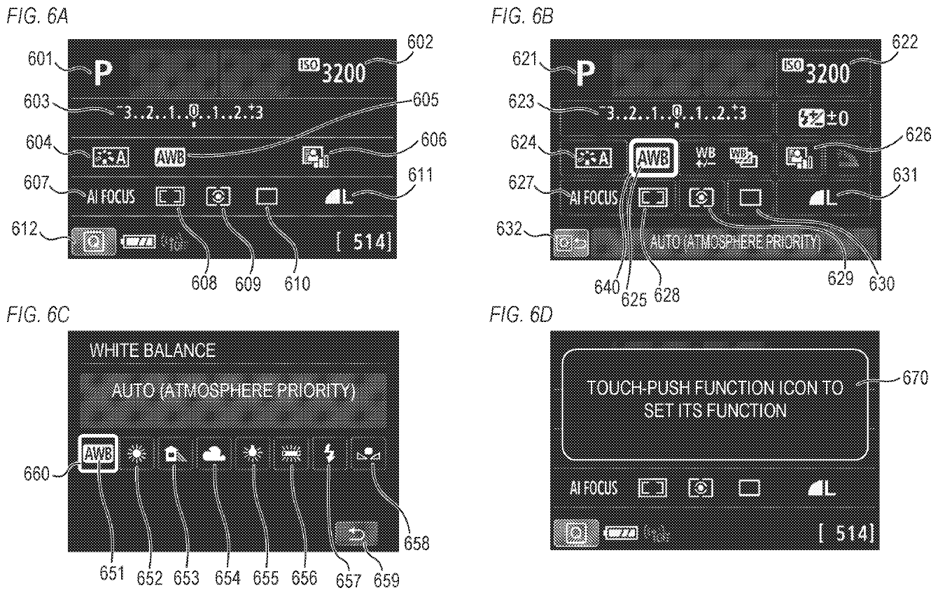

In S301, the system control unit 50 displays a shooting standby screen at the display unit 28. FIG. 6A is an exemplary display on the shooting standby screen. According to the embodiment, when the digital camera 100 is activated in the shooting mode, the system control unit 50 first displays the shooting standby screen shown in FIG. 6A and sets a touch restricted state (locked state) in which touch operation other than on a Q icon 612 is restricted. In this way, erroneous operation due to unintended touch operation on the digital camera 100 can be prevented.

In S302, the system control unit 50 determines whether a touch-down on the touch panel 70a has occurred. When a touch down has occurred, the process proceeds to S303, or else to S311.

In S303, the system control unit 50 determines whether a touch push (pressing which satisfies a predetermined condition) has occurred on the touch panel 70a. The process proceeds to S304 when a touch push has occurred, or else to S305.

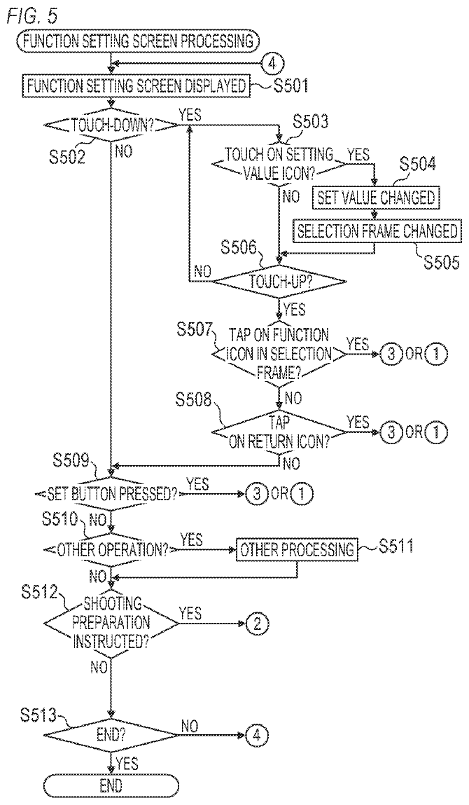

In S304, the system control unit 50 determines whether the touch-pushed position is on a function icon (any of the function icons 601 to 611 in FIG. 6A). When the touch-pushed position is on a function icon, the process proceeds to function setting screen processing and displays a function setting screen corresponding to the touch-pushed function icon among the function icons 601 to 611. For example, when the function icon 605 has been touch-pushed, a white balance setting screen is displayed, and when the function icon 607 has been touch-pushed, an AF mode setting screen is displayed. More specifically, the inherent function (specific function) assigned to the touch-pushed function icon is executed. Details of the function setting screen processing will be described with reference to FIG. 5. When the touch-pushed position is not on a function icon, the process proceeds to S305.

In S305, the system control unit 50 determines whether a touch move has been initiated (started) from a position on a function icon (any of the function icons 601 to 611 in FIG. 6A). When a touch move has been started from a position on a function icon, the process proceeds to S306, or else to S307. The processing in S305 and S306 may be skipped to prevent erroneous operation more surely, and the touch operation other than on the touch push and operation on the Q icon 612 may not be accepted in the locked state. More specifically, in the locked state, function execution by at least particular touch operation (a tap according to the embodiment) needs only be restricted. In he locked state, a particular kind of touch operation on the entire screen (the entire display surface of the display unit 28) may not be accepted (the Q icon 612 may be removed).

In S306, the system control unit 50 determines whether the movement amount of the touch move started in S305 is at least a predetermined amount. When the movement amount of the touch move is at least the predetermined amount, the process proceeds to the function setting screen processing which will be described with reference to FIG. 5, or else to S307.

In S307, the system control unit 50 determines whether touch-up from the touch panel 70a has occurred. When touch-up has occurred, the process proceeds to S308, or else to S303.

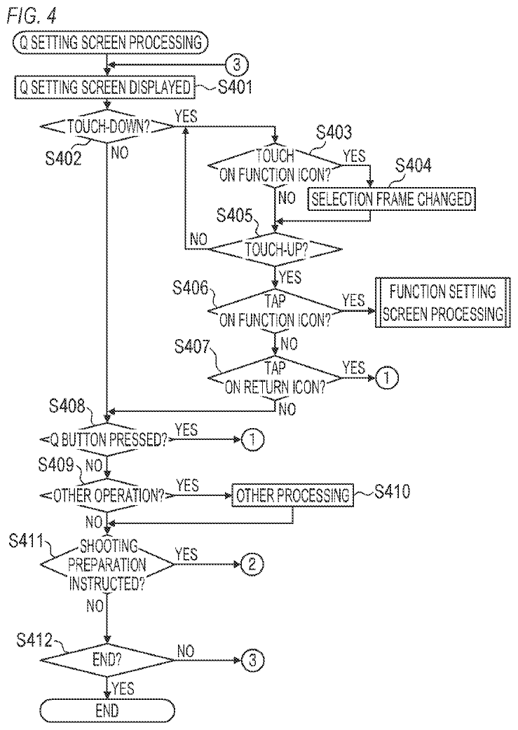

In S308, the system control unit 50 determines whether a tap has occurred on the Q icon 612 in FIG. 6A by the touch-down in S302 and the touch-up in S307. When a tap has been occurred on the Q icon 612, the process proceeds to the Q setting screen processing, or else to S309. Details of the Q setting screen processing will be described with reference to FIG. 4.

In S309, the system control unit 50 determines whether the function icon (any of the function icons 601 to 611 in FIG. 6A) is tapped by the touchdown in S302 and the touch-up in S307. When a tap has occurred on the function icon, the process proceeds to S310, or else to S311.

In S310, the system control unit 50 displays a touch push guide 670 shown in FIG. 6D at the display unit 28 (display control; notification control). The touch push guide 670 is a guide for predetermined notification, more specifically, a guide to inform the user that a touch push on a function icon (each of function icons 601 to 611 in FIG. 6A) can set the function thereof. The touch push guide 670 is automatically hidden in a predetermined period (about 5 seconds). The same touch push guide is displayed in response to a tap on any of the function icons 601 to 611. More specifically, a particular kind of touch operation without a touch push on a function icon (each of the function icons 601 to 611) does not cause the specific function assigned to the touched function icon to be executed. The predetermined notification may be made by other methods such as sound. output.

In S311, the system control unit 50 determines whether the Q button 82 has been pressed. When the Q button 82 has been pressed, the process proceeds to the Q setting screen processing which will be described in conjunction with FIG. 1, or else to S312.

In S312, the system control unit 50 determines whether of other kinds operation have been performed. When any of other kinds of operation is performed, the process proceeds to S313, or else to S314.

In S313, the system control unit 50 performs processing according to the operation. For example, when the sub-electronic dial 73 is turned, setting values such as a shutter speed, an aperture, and an exposure are changed.

In S314, the system control unit 50 determines whether there has been a shooting preparing instruction (shooting preparation instruction such as half-push of the shutter button 61). The process proceeds to S315 when a shooting preparation instruction has been issued, or else the process proceeds to S319.

In S315, the system control unit 50 carries out shooting preparation processing (shooting preparation operation) such as auto focusing (AF) processing, auto exposure (AE) processing, auto white balance (AWB) processing, and flash pre-light emission (EF) processing.

In S316, the system control unit 50 determines whether a shooting instruction has been issued (shooting operation or full-push of the shutter button 61). The process proceeds to S317 when a shooting instruction has been issued, or else to S318.

In S317, the system control unit 50 performs a series of kinds of shooting processing operation starting from reading of a signal from the imaging unit 22 to writing of a captured image as an image file in the recording medium 200.

In S318, the system control unit 50 determines whether a shooting preparation instruction has been issued. The process proceeds to S315 when there has been a shooting preparation instruction, or else to S319.

In S319, the system control unit 50 determines whether an instruction for ending (ending operation) the shooting mode setting processing has been issued. When an ending instruction has been issued, the shooting mode setting processing ends or else the process proceeds to S301. For example, when an instruction for turning off the power supply of the digital camera 100 has been issued, the system control unit 50 determines that an instruction for ending the shooting mode setting processing has been issued and ends the shooting mode setting processing.

FIG. 4 is a flowchart for illustrating details of the Q setting screen processing performed by the digital camera 100. The processing is carried out as the system control unit 50 deploys and executes a program recorded in the non-volatile memory 56 in the system memory 52. For example, the processing in FIG. 4 starts when the Q icon 612 in FIG. 6A is tapped (YES in S308 in FIG. 3) or the Q button 82 is pressed (YES in S311 in FIG. 3) while the shooting standby screen in FIG. 6A is displayed.

In S401, the system control unit 50 displays the Q setting screen on the display unit 28 (by unlocking the locked. state). FIG. 6B shows an exemplary Q setting screen.

In S402, the system control unit 50 determines whether there has been touch-down to the touch panel 70a. When touch down has, the process proceeds to S403, or else to S408.

In S403, the system control unit 50 determines whether the position (touched position) touched on the touch panel 70a is on a function icon (any of the function icons 621 to 631 in FIG. 6B). When the touched position is on any of the function icons, the process proceeds to S404, or else to S405. The function icons 621 to 631 in FIG. 6B are the same icons (display items) as the function icons 601 to 611 in FIG. 6A.

In S404, the system control unit 50 changes the display of the selecting frame (cursor; focus) 640 in FIG. 6B so that the function icon in the touched position is displayed.

In S405, the system control unit 50 determines whether a touch-up from the touch panel 70a has occurred. When a touch-up has occurred, the process proceeds to S406, or else to S403.

In S406, the system control unit 50 determines whether the function icon has been tapped in the touch-down in S402 and the touch-up in S405 (any of the function icons 621 to 631 in FIG. 6B). When a tap has occurred on the function icon, the process proceeds to the function setting screen processing which will be described with reference to FIG. 5, or else to S407.

In S407, the system control unit 50 determines whether the return icon 632 in FIG. 6B has been tapped in the touch-down in S402 and the touch-up of S405. When the return icon 632 has been tapped, the process proceeds to S301 in FIG. 3, or else to S408.

In S408, the system control unit 50 determines whether the Q button 82 has been pressed. When the Q button 82 has been pressed, the process proceeds to S301 in FIG. 3, or else to S409.

In S409, the system control unit 50 determines whether any of other kinds of operation has been performed. When any of the other kinds of operation has been performed, the process proceeds to S410, or else to S411.

In S410, the system control unit 50 performs processing according to the operation. For example, when the sub-electronic dial 73 is turned, the set value for the function icon shown in the selection frame 640 in FIG. 6B is changed.

In S411, the system control unit 50 determines whether a shooting preparation instruction has been issued. When a shooting preparation instruction has been issued, the process proceeds to S315 in FIG. 3, or else to S412.

In S412, the system control unit 50 determines whether an ending instruction (ending operation) for the Q setting screen processing has been issued. When an ending instruction has been received, the Q setting screen processing ends, or else the process proceeds to S401. For example, when an instruction for turning off the power supply of the digital camera 100 has been issued, the system control unit 50 determines that an instruction for ending the Q setting screen processing has been issued and ends the Q setting screen processing.

FIG. 5 is a flowchart for illustrating details of the function setting screen processing performed by the digital camera 100. The processing is carried out as the system control unit 50 deploys and executes a program recorded in the non-volatile memory 56 in the system memory 52. For example, the processing in FIG. 5 starts when any of the Function icons 601 to 611 in FIG. 6A has been touch-pushed (YES in S304 in FIG. 3) or there has been a touch-move from any of the function icons 601 to 611 (YES in S306 in FIG. 3). When any of the function icons 621 to 631 in FIG. 6B has been tapped (YES in S406 in FIG. 4), the processing in FIG. CCD starts.

In S501, the system control unit 50 displays the function setting screen at the display unit 28. FIG. 6C shows an exemplary function setting screen. Here, the function setting screen corresponding to any of the function icon touch-pushed on the shooting standby screen in FIG, 6A, the function icon in the starting position of the touch move on the shooting standby screen in FIG. 6A, and the function icon tapped on the Q setting screen in FIG. 6B are displayed.

In S502, the system control unit 50 determines whether there has been a touch-down on the touch panel 70a. When a touch down has occurred, the process proceeds to S503, or else to S509.

In S503, the system control 50 determines whether the position (touched position) touched on the touch panel 70a is on a setting value icon (any of the setting value icons 651 to 658 in FIG. 6C). When the touched position is on a setting value icon, the process proceeds to S504, or else to S506.

In S504, the system control unit 50 changes the set value for the function corresponding to the function setting screen being displayed to a set value corresponding to the setting value icon in the touched position and records the set value in the system memory 52.

In S505, the system control unit 50 changes the display of the selection frame (cursor; focus) 660 in FIG. 6C so that the setting value icon in the touched position is indicated.

In S506, the system control unit 50 determines whether a touch-up from the touch panel 70a has occurred. When a touch-up has occurred, the process proceeds to S507, or else to S503.

In S507, the system control unit 50 determines whether the touch-down in S502 and the touch-up in S506 are performed on the setting value icon shown in the selection frame 660 in FIG. 6C. When the setting value icon shown in selection frame 660 has been tapped, the process proceeds to S401 in FIG. 4, or else to S508. In this way, when the display screen is changed from the shooting standby screen to the function setting screen by a touch push or a touch move on the shooting standby screen, the locked state is unlocked and an unlocked state (unrestricted state) is attained in response to the tap on the setting value icon shown in the selection frame 660. In the above case in which the display screen has changed from the shooting standby screen to the function setting screen, the process may proceed to S301 in FIG. 3 to maintain the locked state in response to a tap on the setting value icon shown in the selection frame 660,

In S508, the system control unit 50 determines whether a tap has occurred on the return icon 659 in FIG. 6C in the touch down in S502 and the touch up in S506 performed. When a tap has occurred on the return icon 659, the process proceeds to S401 in FIG. 4, or else to S509. In this way, when the display screen has changed from the shooting standby screen to the function setting screen by a touch push or touch move on the shooting standby screen, the locked state is unlocked and an unlocked state is attained in response to the tap on the return icon 659. In the above case in which the display screen has changed from the shooting standby screen to the function setting screen, the process may proceed to S301 in FIG. 3 to maintain the locked state in response to the tap on the return icon 659.

In S509, the system control unit 50 determines whether the SET button 75 has been pressed. When the SET button 75 has been pressed, the process proceeds to S401 in FIG. 4, or else to S510. In this way, when the display screen has changed from the shooting standby screen to the function setting screen by a touch push or a touch move on the shooting standby screen, the locked status is unlocked and an unlocked state is attained in response to pressing of the SET button 75. In the above case in which the display screen has changed from the shooting standby screen to the function setting screen, the display may proceed to S301 in FIG. 3 to maintain the locked. state in response to the pressing of the SET button 75.

In S510, the system control unit 50 determines whether any of other kinds of operation has been performed. When any of other kinds of operation has been performed, the process proceeds to S511, or else to S512.

In S511, the system control unit 50 performs processing according to the operation. For example, when the sub-electronic dial 73 is turned, the setting value for the function corresponding to the function setting screen being displayed is changed, the value is recorded in the system memory 52, and the display of the selection frame 660 in FIG. 6C is changed to show the setting value icon corresponding to the set value after the change.

In S512, the system control unit 50 determines whether a shooting preparation instruction has been issued. When the shooting preparation instruction has been issued, the process proceeds to S315 in FIG. 3, or else to S513.

In S513, the system control unit 50 determines whether an ending instruction (ending operation) for the function setting screen processing has been issued. When the ending instruction has been issued, the function setting screen processing ends, or else the process proceeds to S501. For example, when an instruction for turning off the power supply of the digital camera 100 has been issued, the system control unit 50 determines that an ending instruction for the function setting screen processing has been issued, and ends the function setting screen processing.

As in the foregoing, according to the described embodiment, the possibility of erroneous operation due to unintended touches can be reduced and a desired function can be executed with a smaller number of operations. Specifically, in the conventional case in which no touch operation is accepted other than operation on the Q icon 612 on the shooting standby screen in FIG. 6A, at least two kinds of operation are required. The first operation is operation for unlocking a locked state for example by tapping the Q icon 612 or pressing the Q button 82 (operation for changing the display screen from the shooting standby screen to the Q setting screen (FIG. 6B)). The second operation is operation for moving the display screen from the Q setting screen to the function setting screen (FIG. 6C) for example by tapping a function icon (any of the function icons 621 to 631 in FIG. 6B) on the Q setting screen. Meanwhile, according to the embodiment, the display screen can be changed from the shooting standby screen to the function setting screen by one operation for example by touching the function icon (any of the function icons 601 to 611 in FIG. 6A) on the shooting standby screen.

It should be noted that no function is executed. even when there is a tap other than on the Q icon 612 on the shooting standby screen in FIG. 6A, but this may be otherwise. For example, in response to a tap on the function icon (any of the function icons 601 to 611 in FIG. 6A) on the shooting standby screen, the value set corresponding to the tapped function icon may be changed without changing the display screen to another screen. Also, in this case, the display screen may be changed to the function setting screen (FIG. 6C) in response to a touch push on the function icon on the shooting standby screen.

The various kinds of control described above as being performed by the system control unit 50 may be performed by a single piece of hardware, or a plurality of pieces of hardware (such as a plurality of processors and circuits) may control the entire device by sharing the processing.

While the present disclosure has been described in detail with reference to the preferred embodiments, the present disclosure is not limited by these specific embodiments, and various forms which do not depart from the gist and spirit of the present disclosure are also encompassed by the present disclosure. Furthermore, each of the embodiments described above is merely indicative of one embodiment of the present disclosure and the embodiments may be combined as appropriate.

In the description of the embodiments, the present disclosure is applied to a digital camera. (imaging device), but the disclosure may be applied to a touch detectable electronic device other than the above. For example, the present disclosure may be applied to a personal computer, a Personal Digital Assistant (PDA), a mobile phone terminal, a portable image viewer, a printer device, a digital photo frame, a music player, a game machine, and an electronic book reader. The present disclosure may also be applied to a video player, a display device (including a projector), a tablet terminal, a smartphone, an Artificial Intelligence (AI) speaker, a home electrical appliance, and a vehicle on-board device.

An example of applying the present disclosure to a smartphone will be described. When a predetermined application such as a child lock application is activated, touch operation to the display surface (operation surface of the touch panel) of the display unit is restricted or a locked state is set. In this way, when for example a user moves (for example by walking or jogging) while listening to a sound from a smartphone (a sound from a moving image being played back or an audio content on the web) put in a pocket, erroneous operation due to unintended touch operation can be prevented. In addition, when viewing moving images in a bath or at a kitchen, erroneous operation caused by water droplets on the smartphone can also be prevented. Even in a locked state, some of the functions are executed with a touch push. In this way, for example when a sound (such as a moving image and a song) is played till the end and stopped, when it is desired to play back the next sound, or when it is desired to change the volume, the user can perform a desired function by a touch push without unlocking the locked state.

According to the present disclosure, the possibility of erroneous operation due to unintended touch operation is reduced, and a desired function can be performed with a smaller number of operations.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-038009, filed on Mar. 5, 2020, which is hereby incorporated by reference herein in its entirety.

What is claimed is:

1. An electronic device comprising:
a touch detector configured to detect touch operation on an operation surface;
a pressing detector configured to detect pressing on the operation surface; and
at least one memory and at least one processor which function as:
a setting unit configured to set a restricted state in which function execution by at least particular touch operation is restricted; and
a control unit configured to perform control such that in a non-restricted state, which is not the restricted state, a particular function corresponding to a display item is executed in response to the particular touch operation performed on the display item even when the pressing detector does not detect pressing which satisfies a predetermined condition,
perform control such that in the restricted state, the particular function corresponding to the display item is not executed even when the particular touch operation is performed on the display item in a case where the pressing detector does not detect pressing which satisfies the predetermined condition, and
perform control such that in the restricted state, the particular function corresponding to the display item is executed in a case where the pressing detector detects pressing which satisfies the predetermined condition in a state where the display item is touched.

2. The electronic device according to claim 1, wherein the particular touch operation is operation which does not include movement of a touched position.

3. The electronic device according to claim 2, wherein the particular touch operation is operation including touching the operation surface and releasing the touch without moving the touched position.

4. The electronic device according to claim 1, wherein in the restricted state, the setting unit maintains the restricted state even in a case where the pressing detector detects pressing which satisfies the predetermined condition in a state where the display item is touched.

5. The electronic device according to claim 1, wherein in the restricted state, the setting unit cancels the restricted state in a case where the pressing detector detects pressing which satisfies the predetermined condition in a state where the display item is touched.

6. The electronic device according to claim 1, wherein a screen in the restricted state is a shooting standby screen, which is not a screen displaying a live view.

7. The electronic device according to claim 1, wherein in the restricted state, the control unit performs control such that the particular function corresponding to the display item is executed in response to touch operation performed, the touch operation including touching the display item and moving the touched position, even when the pressing detector does not detect pressing which satisfies the predetermined condition.

8. The electronic device according to claim 1, wherein in the restricted state, the setting unit cancels the restricted state in response to touch operation performed on a particular display item.

9. The electronic device according to claim 1, further comprising a notification control unit configured to perform control such that in the restricted state, predetermined notification is performed in response to the particular touch operation performed on the display item in a case where the pressing detector does not detect pressing which satisfies the predetermined condition.

10. The electronic device according to claim 9, wherein the predetermined notification is a notification that the particular function corresponding to the display item is executed by touching the display item and performing pressing which satisfies the predetermined condition.

11. The electronic device according to claim 1, wherein the particular function is a function of changing a display screen to a screen for setting corresponding to the display item. The electronic device according to claim 1, wherein the pressing which satisfies the predetermined condition is pressing of at least a predetermined threshold value.

13. The electronic device according to claim 1, wherein the pressing which satisfies the predetermined condition is pressing of at least a predetermined pressing force.

14. The electronic device according to claim 1, wherein the control unit performs control such that in the restricted state, the particular function corresponding to the display item is not executed in a case where, even when pressing which satisfies the predetermined condition is detected, the pressing is not pressing to a position corresponding to the display item in the operation surface.

15. The electronic device according to claim 1, wherein the control unit performs control such that both in the non-restricted state and the restricted state, the display item is displayed in a same position in the operation surface.

16. The electronic device according to claim 15, wherein the control unit performs control such that both in the non-restricted state and the restricted state, a plurality of display items respectively corresponding to different functions including the display item are displayed in a same arrangement and in same positions on the operation surface.

17. A control method of an electronic device, comprising:
detecting touch operation on an operation surface;
detecting pressing on the operation surface;
setting a restricted state in which function execution by at least particular touch operation is restricted;
performing control such that in a non-restricted state, which is not the restricted state, a particular function corresponding to a display item is executed in response to the particular touch operation performed on the display item even when pressing which satisfies a predetermined condition is not detected;
performing control such that in the restricted state, the particular function corresponding to the display item is not executed even when the particular touch operation is performed on the display item in a case where pressing which satisfies the predetermined condition is not detected; and
performing control such that in the restricted state, the particular function corresponding to the display item is executed in a case where pressing which satisfies the predetermined condition is detected in a state where the display item is touched.

18. A non-transitory computer readable medium that stores a program, wherein
the program causes a computer to execute a control method of an electronic device, the method comprising:
detecting touch operation on an operation surface;
detecting pressing on the operation surface;
setting a restricted state in which function execution by at least particular touch operation is restricted;
performing control such that in a non-restricted state, which is not the restricted state, a particular function corresponding to a display item is executed in response to the particular touch operation performed on the display item even when pressing which satisfies a predetermined condition is not detected;
performing control such that in the restricted state, the particular function corresponding to the display item is not executed even when the particular touch operation is performed on the display item in a case where pressing which satisfies the predetermined condition is not detected; and
performing control such that in the restricted state, the particular function corresponding to the display item is executed in a case where pressing which satisfies the predetermined condition is detected in a state where the display item is touched.
